(19) United States
(12) Patent Application Publication
(10) Pub. No.: US 2004/0264369 A1
(43) Pub. Date: Dec. 30, 2004

(54) Scalable network for computing and data storage management

(75) Inventors: Coke S. Reed, Cranbury, NJ (US); David Murphy, Austin, TX (US)

Correspondence Address: KOESTNER BERTANI LLP, 18662 MACARTHUR BLVD, SUITE 400, IRVINE, CA, 92612, US

(73) Assignee: Interactic Holdings, LLC, New York, NY

(21) Appl. No.: 10/798,526

(22) Filed: Mar. 11, 2004

Related U.S. Application Data
(60) Provisional application No. 60/454,172, filed on Mar. 11, 2003.
(60) Provisional application No. 60/461,548, filed on Apr. 7, 2003.

(51) Int. Cl. H04L 12/56

(52) U.S. Cl. 370/229; 370/394; 370/462

(57) ABSTRACT

A communication apparatus comprises a controlled switch capable of communicating scheduled messages and interfacing to a plurality of devices, and an uncontrolled switch capable of communicating unscheduled messages and interfacing to the plurality of devices. The uncontrolled switch generate signals that schedule the messages in the controlled switch.

### RELATED PATENT AND PATENT APPLICATIONS

The disclosed system and operating method are related to subject matter disclosed in the following patents and patent applications that are incorporated by reference herein in their entirety:

1. U.S. Pat. No. 5,996,020 entitled, “A Multiple Level Minimum Logic Network”, naming Coke S. Reed as inventor;

2. U.S. Pat. No. 6,289,021 entitled, “A Scaleable Low Latency Switch for Usage in an Interconnect Structure”, naming John Hesse as inventor;

3. U.S. patent application Ser. No. 09/693,359 entitled, “Multiple Path Wormhole Interconnect”, naming John Hesse as inventor;

4. U.S. patent application Ser. No. 09/693,357 entitled, “Scalable Wormhole-Routing Concentrator”, naming John Hesse and Coke Reed as inventors;

5. U.S. patent application Ser. No. 09/693,603 entitled, “Scaleable Interconnect Structure for Parallel Computing and Parallel Memory Access”, naming John Hesse and Coke Reed as inventors;

6. U.S. patent application Ser. No. 09/693,358 entitled, “Scalable Interconnect Structure Utilizing Quality-Of-Service Handling”, naming Coke Reed and John Hesse as inventors;

7. U.S. patent application Ser. No. 09/692,073 entitled, “Scalable Method and Apparatus for Increasing Throughput in Multiple Level Minimum Logic Networks Using a Plurality of Control Lines”, naming Coke Reed and John Hesse as inventors;

8. U.S. patent application Ser. No. 09/919,462 entitled, “Means and Apparatus for a Scaleable Congestion Free Switching System with Intelligent Control”, naming John Hesse and Coke Reed as inventors;

9. U.S. patent application Ser. No. 10/123,382 entitled, “A Controlled Shared Memory Smart Switch System”, naming Coke S. Reed and David Murphy as inventors.

### BACKGROUND

Interconnect network technology is a fundamental component of computational and communications products ranging from supercomputers to grid computing switches to a growing number of routers. However, characteristics of existing interconnect technology result in significant limits in scalability of systems that rely on the technology.

For example, even with advances in supercomputers of the past decade, supercomputer interconnect network latency continues to limit the capability to cost-effectively meet demands of data-transfer-intensive computational problems arising in the fields of basic physics, climate and environmental modeling, pattern matching in DNA sequencing, and the like.

For example, in a Cray T3E supercomputer, processors are interconnected in a three-dimensional bi-directional torus. Due to latency of the architecture, for a class of computational kernels involving intensive data transfers, on the average, 95% to 98% of the processors are idle while waiting for data. Moreover, in the architecture about half the boards in the computer are network boards. Consequentially, a floating point operation performed on the machine can be up to 100 times as costly as a floating point operation on a personal computer.

As both computing power of microprocessors and the cost of parallel computing have increased, the concept of networking high-end workstations to provide an alternative parallel processing platform has evolved. Fundamental to a cost-effective solution to cluster computing is a scalable interconnect network with high bandwidth and low latency. To date, the solutions have depended on special-purpose hardware such as Myrinet and QsNet.

Small switching systems using Myrinet and QsNet have reasonably high bandwidth and moderately low latency, but scalability in terms of cost and latency suffer from the same problems found in supercomputer networks because both are based on small crossbar fabrics connected in multiple-node configurations, such as Clos network, fat tree, or torus. The large interconnect made of crossbars is fundamentally limited.

A similar scalability limit has been reached in today's Internet Protocol (IP) routers in which a maximum of 32 ports is the rule as line speeds have increased to OC192.

Many years of research and development have been spent in a search for a “scalable” interconnect architecture that will meet the ever-increasing demands of next-generation applications across many industries. However, even with significant evolutionary advancements in the capacity of architectures over the years, existing architectures cannot meet the increasing demands in a cost-effective manner.

### SUMMARY OF THE INVENTION

A communication apparatus comprises a controlled switch capable of communicating scheduled messages and interfacing to a plurality of devices, and an uncontrolled switch capable of communicating unscheduled messages and interfacing to the plurality of devices. The uncontrolled switch generates signals that schedule the messages in the controlled switch.

### BRIEF DESCRIPTION OF THE DRAWINGS

Embodiments of the illustrative systems and associated technique relating to both structure and method of operation, may best be understood by referring to the following description and accompanying drawings.

FIG. 1A is a schematic block diagram that illustrates multiple computing and data storage devices connected to both a scheduled network and an unscheduled network.

FIG. 1B is a schematic block diagram showing the system depicted in FIG. 1A with the addition of control lines associated with the unscheduled switch.

FIG. 1C is a block diagram depicting the system shown in FIGS. 1A and 1B with an auxiliary switch decomposed into a set of small switches, for example crossbar switches. The present invention relates to a method and means of interconnecting a plurality of devices for the purpose of passing data between said devices. The devices include but are not limited to: 1) computing units such as work stations; 2) processors in a supercomputer; 3) processor and memory modules located on a single chip; 4) storage devices in a storage area network; and 5) portals to a wide area network, a local area network, or the Internet. The invention also relates to the management of the data passing through the interconnect structure.

FIG. 2 is a schematic block diagram showing a switch suitable for usage in carrying unscheduled traffic.

FIG. 3 is a schematic block diagram showing a switch suitable to be used for carrying scheduled traffic.

FIG. 4 is a schematic diagram illustrating connections for delivering data from a scheduled network to devices exterior to the scheduled network.

FIG. 5A is a block diagram that illustrates replacement of a single switch chip with a switch on a plurality of chips, resulting in lowering the pin count per chip.

FIG. 5B is a schematic block diagram that illustrates replacement of a single switch chip with a switch on a plurality of chips in a system with the property that at least one individual switch chip does not receive data from every device.

FIGS. 6A through 6D are schematic block diagrams that illustrate systems with a plurality of MLML networks connected in a “twisted cube” configuration. The networks shown are suitable for use in either a scheduled or an unscheduled configuration. FIG. 6B illustrates a network utilizing the topology shown in FIG. 6A with the addition of logic elements for scheduling messages. FIG. 6C shows the path of a message packet from a device making a data request to a data sending device. FIG. 6D illustrates the return path of a message from a data sending device through a scheduling logic element to the device that requests data.

FIG. 7A illustrates a collection of devices and networks in an alternative configuration. FIG. 7B illustrates a collection of interconnect lines and FIFOs used to interconnect networks of FIG. 7A.

### DETAILED DESCRIPTION

In a wide variety of computing and communication systems, processors and storage devices communicate via a network. The interconnect structures described in the referenced related patents and co-pending applications are useful for interconnecting a large number of devices when low latency and high bandwidth are important. The illustrative interconnects have the property of being self-routing, enabling improved performance. The ability of the networks to simultaneously deliver multiple packets to a particular network output port can also be useful.

The references 1, 2, 3, 4, 6 and 7 teach the topology, logic, and use of the variations of a revolutionary interconnect structure. This structure is referred to in reference 1 as a “Multiple Level Minimum Logic” (MLML) network and has been referred to elsewhere as the “Data Vortex”. Reference 8 shows how the Data Vortex can be used to build next generation communication products, including routers. The Hybrid Technology Multi Threaded (HTMT) petaflop computer used an optical version of the MLML network. In that architecture all message packets are of the same length. Reference 5 teaches a method of parallel computation and parallel memory access within the network.

The Internet Protocol (IP) router specifications are fundamentally different than the Computing and Storage Area Network (CASAN) specifications. In the router environment, the network is primarily “input driven” since message packets arriving at a switch are targeted for output ports. One task of input driven systems is arbitration between messages targeted for the same output port. If more messages are targeted for a given output port than the system can handle, some of the messages are discarded. A router can be used to discard lower priority messages and send high priority messages. Effective arbitration and network schedule management for scaleable next generation routers is taught in the reference 8 using “request processors.” A given request processor arbitrates between all of the messages targeted for an output port managed by that request processor. In CASAN systems the network is primarily “output driven” in that a device located at a given network output port requests data to be sent. Output driven port devices do not request more data than can be handled so that discarding of data can be avoided.

The illustrative techniques and structures are capable of interconnecting multiple devices for the purpose of passing data between said devices. The devices include but are not limited to: 1) computing units such as work stations; 2) processors in a supercomputer; 3) processor and memory modules located on a single chip; 4) storage devices in a storage area network; and 5) portals to a wide area network, a local area network, or the Internet. The techniques further relate to the management of the data passing through the interconnect structure.

The systems, devices, and functions disclosed in the patents and patent applications referenced hereinabove can be used in supercomputing, cluster computing, and storage area networks. The present disclosure describes structures and methods in a computing and storage area network (CASAN) system that can be implemented using the disclosed systems, devices, and functions.

In accordance with some embodiments, a system is capable of responding to long message requests from network output port devices and delivering, without interruption, the long messages composed of multiple packets or records. System operation includes two portions, a “scheduled or managed” output driven portion and an “unscheduled or unmanaged” portion. The scheduled or managed system operation portion includes delivery of data to requesting devices located at an output port. The unscheduled or unmanaged portion includes requests for sending data to the output port. Many applications have more scheduled traffic than unscheduled traffic in the network. The disclosed system can perform space-time division of an interconnect structure to effectively handle both unscheduled and scheduled traffic.

In some embodiments, the disclosed system can provide multiple connections into a device positioned to receive data from the network. Data targeted to the device can be targeted to a selected port of the device, conveniently avoiding message re-assembly. Data arrives at the processor “Just in Time” to be used. The “Just in Time” computing model eliminates the necessity of large processor caching and hiding of memory latency by multi-threading microprocessor architectures. Targeting of data for a given port of a device can eliminate or shorten the operation code for a message. For example, a processor requesting data item X_{A} from source A and data item X_{B} from source B for the purpose of performing a function F (X_{A}, X_{B}) can schedule X_{A} to enter port P_{A} and schedule X_{B} to enter port P_{B} so that the arrival of the arguments to perform the function F triggers the application of function F to the variables. Data can be scheduled to stream into certain processor ports and can be scheduled to stream out other processor ports, resulting in smooth and extremely efficient data transfer. The streaming feature is useful in applications with computational kernels in linear algebra, Fourier analysis, searches, sorts, and a number of other computational tasks that involve massive data movement. In cases where a given processor chip contains a plurality of processing-in-memory modules (PIM chips), different data paths can be configured to deliver data through different data paths and to different modules of the system. Streams can come in a variety of forms. For example, in one application port P_{A} can be scheduled to receive data from a first processor at even times and from a second processor at odd times. The properties of the network enable a time-sharing form of computation because, in cases where the data is scheduled by data receiving ports to prevent system overload, data entering the network on a given cycle is scheduled to leave the network at a fixed time cycle in the future.

A highly useful capability of the network topologies and control systems disclosed in the referenced related patents and applications is that data streaming from a source S to a destination D does not use the setting up of a dedicated path from S to D. In fact as other data streams are continuously and dynamically set up and deleted between different source and destination pairs, the data from S to D will move from path to path. In the illustrative data network, the stream from S to D will neither interfere nor receive interference from other data streams in the network.

The disclosed system can be configured with a capability to enforce quality of service.

In various embodiments, the disclosed can send both scheduled and unscheduled data through networks that are variants of the networks described in the listed related patents and applications. In a simple embodiment, unscheduled messages and the scheduled messages pass through separate networks. A particular example embodiment includes two networks: a first network U carries unscheduled message packets and a second network S carries scheduled messages. The listed reference 8 has unscheduled networks that are used as request and answer switches. In contrast data switches are used as scheduled networks. The unscheduled message network U can be a “flat latency” or “double down” network of the type disclosed in related reference 2. Scheduled network S can be a “flat latency or double down” network using the “stair-step” design of the type illustrated and used as a data switch.

For the case that a plurality of messages are inserted into network U at a given message packet insertion time, and N of the messages are targeted for the same output port P and fewer than N data lines exist through network U to output port P, then at most N of the messages pass from network U to output port P at a one time. Accordingly, some messages wrap around the cylinders and move into output port P after passing port P one or more times. The scheduled network is designed so that, corresponding to the output port P, if an integer number Pmax or fewer messages are sent from the various input ports at a given message scheduling time, then all of the messages exit the port P without moving around the cylinder to make more than one attempt to exit at the proper output port. To guarantee that Pmax messages can exit at output port P, port P is designed with Pmax or more connections to the network S.

The system operates as follows: a device connected to unscheduled message network U is free to send a message packet into network U at any message sending time, but a device connected to scheduled message network S may only insert messages into combined network S at times that are previously scheduled. One method of operation, as well as examples using both networks U and S, follow.

In a first example, devices D_{A} and D_{B} are each connected to both networks S and U. Device D_{A} sends a packet R_{P} through network U to device D_{B} and packet R_{P} requests selected data from device D_{B}. In an embodiment with a plurality of connections from network S to device D_{A} and the connections designed to carry data from network S to device D_{A}, device D_{A} may designate a selected input port to receive the data. The request packet R_{P} may also include information concerning an acceptable time or times for the data to be sent. In case device D_{B} is able to fulfill the request, the transmission begins in the prescribed time window and the data is transferred sequentially from device D_{B} to device D_{A}. In case the device D_{B} is not able to send the requested data in the allotted time period, the device sends an answer message packet to device D_{A} indicating the impossibility of fulfilling the request and possibly making suggestions for an alternate sending schedule in a different time frame. In case device D_{B} is able to fulfill the request, the data is sent to the requested port at the requested time. In some cases, for example when device D_{B} can send the data according to multiple time choices, device D_{B} sends an answer packet to device D_{A}. The request may be to send a data set including multiple packets beginning at a designated time T. If so, data will arrive in a continuous stream and in consecutive order until the entire request is satisfied. The logic of device D_{B} is able to enforce quality of service (QoS) of systems utilizing QoS. QoS methods are disclosed in related reference 8. For example, in case multiple lines connect from a device D_{S} to a top switch, one or more of the lines can be reserved for high QoS messages. The ability of the system to enforce quality of service is highly useful in many network applications.

In a second example, three devices D_{A}, D_{B} and D_{C} are connected to both networks S and U. Device D_{A} can request device D_{B} to send packets P₀, P₁, P₂, . . . , P_{K} to device D_{A} input port PT₀ when the transfer is possible and can also request device D_{C} to send packets Q₀, Q₁, Q₂, . . . , Q_{K} to device D_{A} input port P_{T}, when the transfer is possible. Device D_{A} holds ports PT₀ and PT₁ open until the transfer is completed with the completion indicated by the use of one or more counters, by a last packet token, or by other techniques or methods. Each of devices D_{B} and D_{C} begin the transfer when possible and send the packets in sequential order in K contiguous segment delivery insertion times.

In a third more complicated example, the three devices D_{A}, D_{B} and D_{C} are connected to both networks S and U in the same manner as is described in the second example. At a time T, device D_{A} requests that device D_{B} send a selected set of packets P₀, P₁, P₂, . . . , P_{K} at times T+100+2·0, T+100+2·1, T+100+2·2, . . . T+100+2·(K−1) to device D_{A} input port PT₀. Device D_{A} also requests device D_{C} to send packets Q₀, Q₁, Q₂, . . . , Q_{K} at times T+100+(2·0+1), T+100+(2·1+1), T+100+(2·2+1), . . . T+100+(2·K+1) to device D_{A} input port PT₀. Accordingly, device D_{A} receives the two interleaved sequences. Scheduling considerations may infer sending of several unscheduled messages between devices D_{A}, D_{B} and D_{C} until the scheduled event can occur. The arrival of the sequences may coincide with the device D_{A} scheduling the sending of a function F(P,Q) to yet another device D_{X}, with the sending of F(P,Q) occurring during function computation. Accordingly, device D_{A} can receive, compute and send the data without using memory with data streaming through the computational function without being stored.

A fourth example combines features from examples two and three. As before, three devices D_{A}, D_{B} and D_{C} are connected to both networks S and U. At a time T, device D_{A} requests device D_{B} to send packets P₀, P₁, P₂, . . . P_{K} at times T+100, T+100+1, T+100+2, . . . T+100+(K−1) to device D_{A} input port PT₀. Device D_{A} also requests device D_{C} to send packets Q₀, Q₁, Q₂, . . . Q_{K} at times T+100, T+100+1, T+100+2, . . . T+100+(K−1) to device DA input port PT₁. Note that device D_{A} request specifies the two sets of packets to arrive simultaneously and synchronously, but at different input ports. As noted in example three, scheduling of the transfers might be possible only through communication of multiple unscheduled messages between the devices D_{A}, D_{B} and D_{C}, during which the arrival time (T+100) of the first packet may be renegotiated. The device D_{A} requests the packets P and Q to form the function F (P, Q) on each of the packets and send the result to the device D_{X}. The device D_{A} performs the function F (P, Q) on the packet pairs directly upon arrival at the expected input ports of device D_{A} and forwards the results to device D_{X} when computed

In case the function F (P, Q) can be performed in less time than the time elapsed to receive a packet, then the sequence P can be delivered to device D_{A} input port PT₀ sequentially at times T+100 through T+100+(K−1), and the sequence Q can be delivered to input port PT₁ concurrently with the delivery of P to port PT₀. In the same time frame, device D_{A} can deliver the sequence F (P, Q) to D_{X} as the function is computed.

In the case of scheduling N streams to simultaneously arrive at a device D_{X} at pre-assigned ports of a predetermined device, one technique that always works is for the device requesting the scheduling to send request packets to the N different processors. The request packet contains available times to begin the transmission. Each of the processors receiving the request sends a reply packet listing times the processor is available that are consistent with the times specified in the request packet. The available times all include a half line set of the form [K, ∞]. The intersection of the half lines has a minimum member that is acceptable to the receiving node as well as to all of the sending nodes. The scheduling device sends another confirmation packet indicating when the transmission begins. A device receiving the original request packet holds a line free to carry data at the times contained in the answer packet until the confirmation packet is received. Upon receiving the confirmation packet, the sending devices modify their tables containing available times. The entire process is accomplished by the requesting device sending N request packets, having N reply packets returned to the device and finally, having the requesting device send N confirmation packets.

If a selected number of packet reception times are used to perform the function F(P,Q), for example represented by letter J, J processors can be assigned to perform the task with each of the J processors receiving data just in time to perform the calculation. Each of the J processors sends results to device D_{X} as the results are computed, so that device D_{X} receives the results in a stream through a pre-assigned input port.

In the examples, the fact that the latency through the scheduled network is a fixed constant is exploited. The fixed latency results from elimination of buffers in some embodiments of the scheduled network and enables avoidance of buffering in the processor's input and output queues. Therefore, data streaming through the scheduled network enables the data streaming through the processors with the arrival of the data occurring just in time for processing.

The illustrative examples illustrate some of the capabilities of the data processing system. Numerous other examples will be immediately obvious to one of ordinary skill in the art.

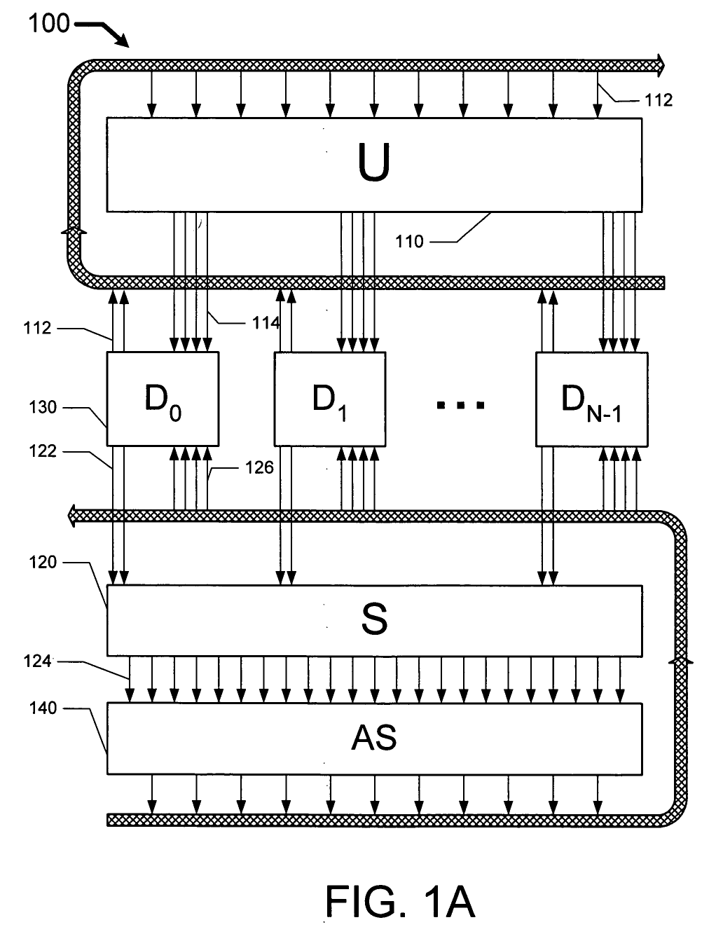

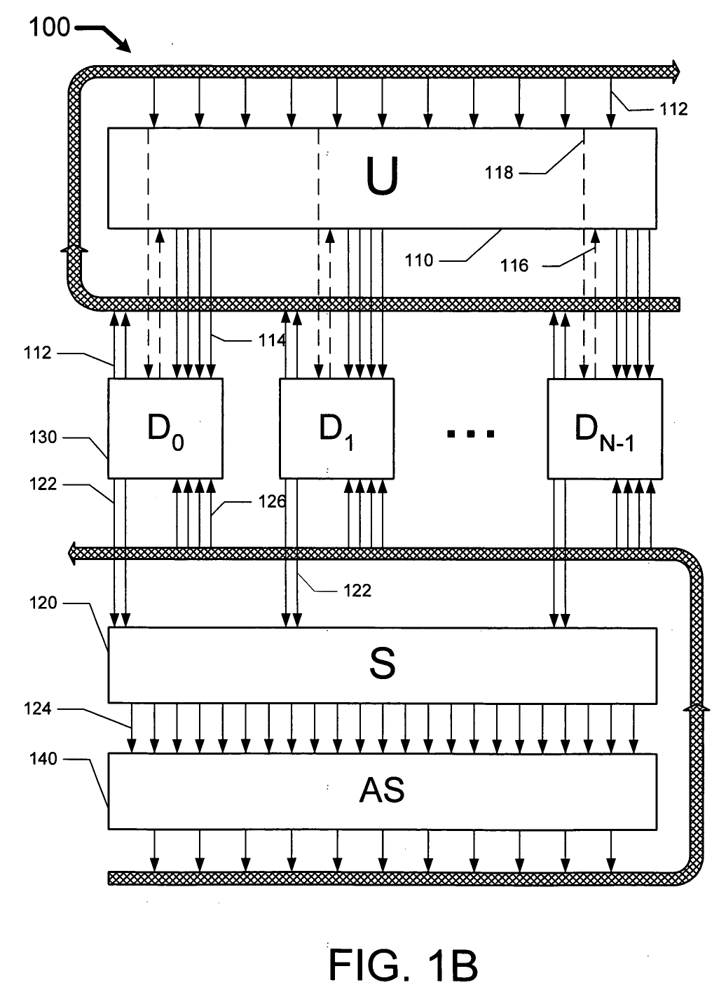

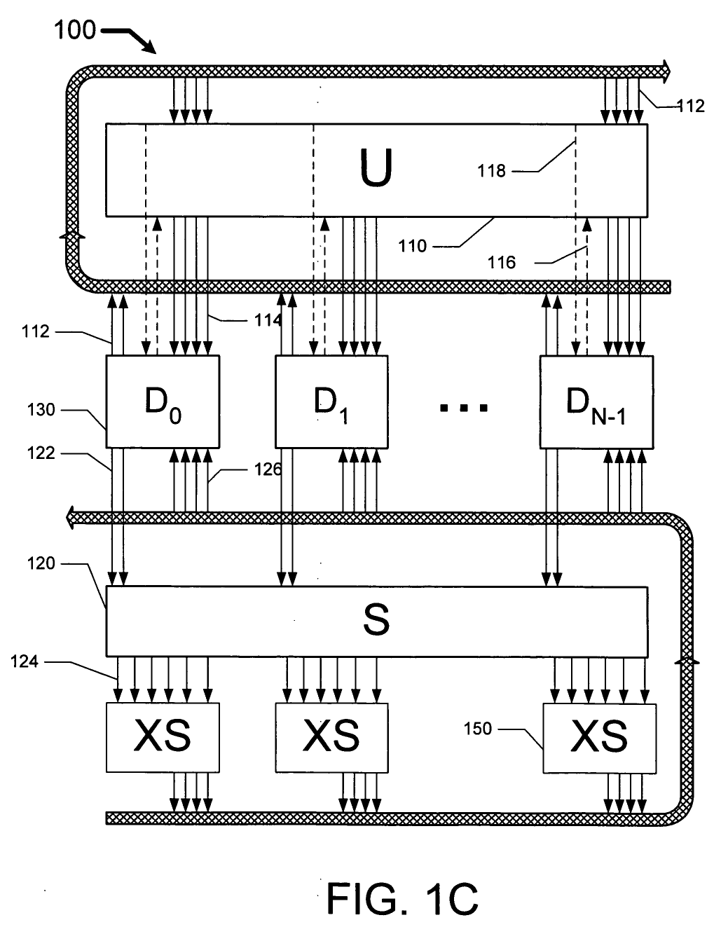

Referring to FIG. 1A, the disclosure describes a system 100 that has a plurality of networks including a network U 110 and a network S 120 with networks S and U connecting a plurality of devices 130. The devices 130 may include devices that are capable of computation; devices that are capable of storing data; devices that are capable of both computation and data storage; and devices that form gateways to other systems, including but not limited to Internet Protocol portals, local and wide area networks, or other types of networks. In general, the devices 130 may include all types of devices that are capable of sending and receiving data.

The Unscheduled or Uncontrolled Switch

Unscheduled or uncontrolled network switch U receives data from devices 130 through lines 112. Switch U sends data to devices through lines 114. Scheduled or controlled network switch S 120 receives data from devices through lines 122 and sends data to external devices through auxiliary switches AS 140. Data passes from network S 120 to the auxiliary switch 140 via line 124 and passes from the auxiliary switch 140 to the device D via lines 126.

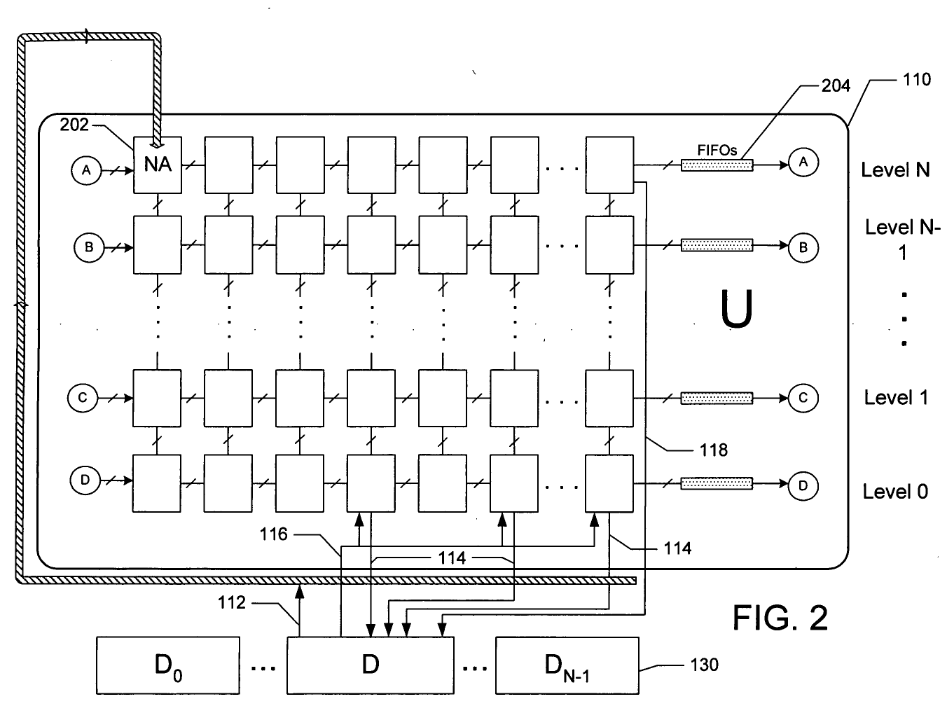

Referring to FIG. 1B in conjunction with FIG. 2, a schematic block diagram shows the interconnection of arrays of nodes NA 202 in a “flat latency switch” of the type disclosed in the related reference 2 that is incorporated by reference into the present disclosure. Network 110 comprises node arrays 202 arranged in rows and columns. Network 110 is well-suited for usage in the unscheduled network U and is used in an illustrative embodiment. Network 110 is self-routing and is capable of simultaneously delivering multiple messages to a selected input port. Moreover, network 110 has high bandwidth and low latency and can be implemented in a size suitable for placement on a single integrated circuit chip. Data is sent into the switch from devices D 130 external to the network 110 through lines 112 at a single column and leaves the switch targeted for devices through lines 114. The lines 114 are positioned to carry data from network U 110 to devices 130 through a plurality of columns. In addition to the data carrying lines, a control line 118 is used for blocking a message from entering the structure into a node in the highest level of the network U 110. Control line 118 is used in case a message packet on the top level of the interconnect is positioned to enter the same node at the same time as a message packet entering the interconnect structure from outside of the network U 110 structure. In case the interconnect structure is implemented on an integrated circuit chip, the control signal 118 can be sent from a top level node to devices 130 that send messages into network U 110.

An embodiment has N pins that carry the control signals to the external devices, with one pin corresponding to each device. In other embodiments, fewer or more pins can be dedicated to the task of carrying control signals.

In another embodiment, that is not shown, a first-in-first-out (FIFO) with a length greater than N and a single pin, or a pair of pins in case differential logic is employed, are used for carrying control signals to the devices D₀, D₁, . . . , D_{N-1}. At a time T₀ the pin carries a control signal to device D₀. At time T₀+1 the pin carries a control signal for device D₁, and so forth, so that at time T₀+k, the pin carries the control signal for device D_{N+k}. The control signals are delivered to a control signal dispersing device, not shown, that delivers the signals to the proper devices.

In a third embodiment, also not shown, the pin that delivers data from line 112 to the network U 110 also passes control signals from network U to the external devices. In the third embodiment, the timing is arranged so that a time interval separates the last bit of one message and the first bit of a next message to allow the pin to carry data in the opposite direction. The second and third embodiments reduce the number of pins.

In addition to the control signals from network U to the external devices, control signals connect from the external devices into network U. The purpose of the control signals is to guarantee that the external device input buffers do not overflow. In case the buffers have insufficient capacity to accept additional packets from network U, the external device 130 sends a signal via line 118 to network U to indicate the condition. In a simple embodiment, the signal, for example comprising a single bit, is sent when the device D input buffers have insufficient capacity to hold all the data that can be received in a single cycle through all of the lines 114 from network U 110 to device D 130. If a blocking signal is sent, the signal is broadcast to all of the nodes that are positioned to send data through lines 114. The two techniques for reducing pin count for the control signals out of network U can be used to reduce the pin count for signals into network U.

The Controlled Switch

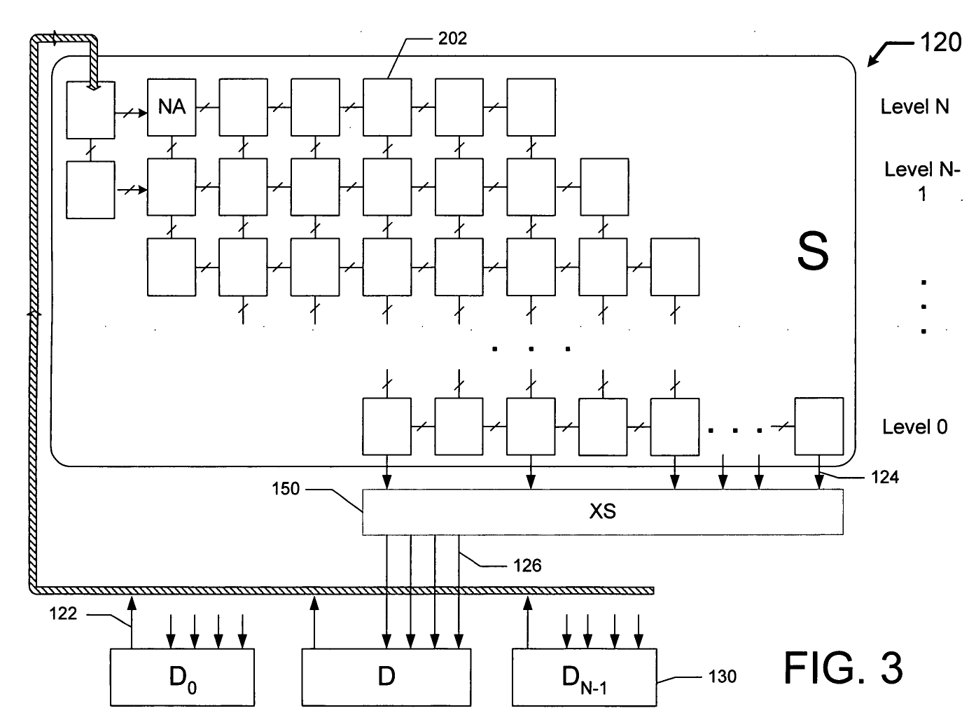

Referring to FIG. 3, a schematic block diagram shows an embodiment of the controlled or scheduled switch or network S 120 that carries scheduled data. The switch 120 comprises interconnected node arrays 202 in a switch that is a subset of the “flat latency switch” described in reference 2. The switch contains some, but not all, of the node arrays of the disclosed flat latency switch. Omitted node arrays are superfluous because the flow into the switch is scheduled so that, based on Monte Carlo simulations, messages never enter the omitted nodes if left in the structure. The switch is highly useful as the center of the switch S 120 and is used accordingly in embodiments that employ one or more of the switches.

Data passes from devices 130 into the switch 120 in a single column through lines 122 and exit the switch 120 in multiple columns through lines 124 into the auxiliary switches AS 140 shown in FIGS. 1A and 1B. The auxiliary switch 140 comprised of a plurality of smaller crossbar switches as illustrated in FIG. 1C. In FIG. 3, one crossbar switch XS 150 receiving data from controlled switch 120 is shown. Data passes from the auxiliary switch 140 to devices 130 external to the switch through lines 126. Switch S 120 may operate without a control signal or a control signal carrying line to warn exterior messages of a collision should the messages enter the switch 120 because messages do not wrap around the top level of the switch 120. For the same reason, the scheduled switch S 120 may operate without first-in-first-out (FIFO) or other buffers.

One method of controlling the traffic through switch S 120 is to send request packets through switch U 110, an effective method for a many applications, including storage array network (SAN) applications. In another application involving parallel computing, including cluster computing), data through switch S is scheduled by a compiler that manages the computation. The system has the flexibility to enable a portion of the scheduled network to be controlled by the network U and a portion of the scheduled network to be controlled by a compiler.

The Auxiliary Output Switch

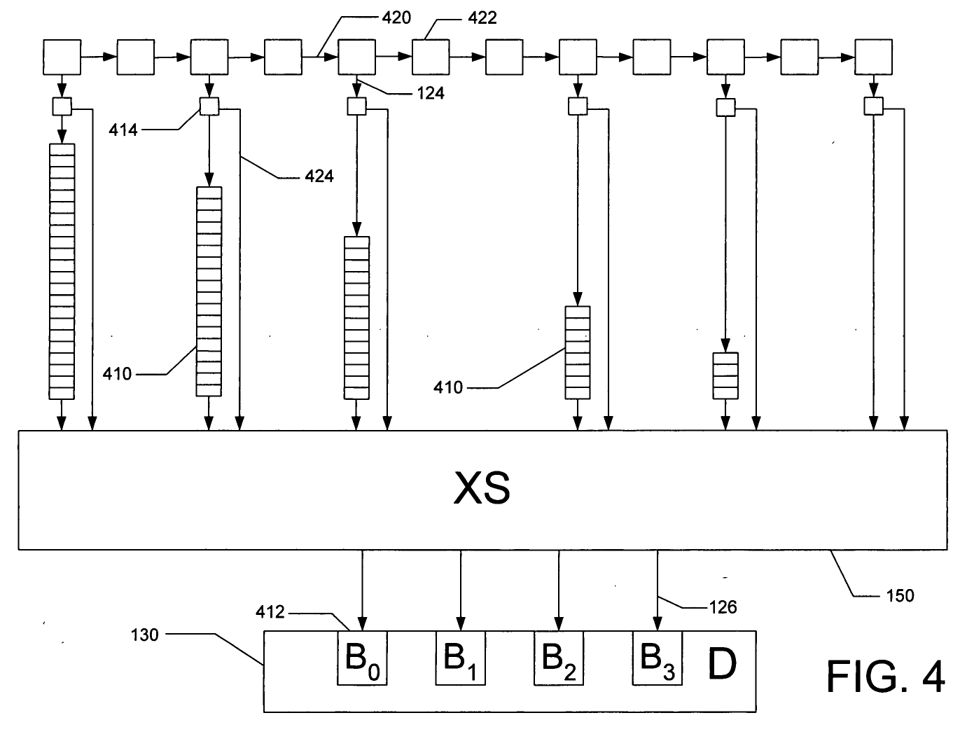

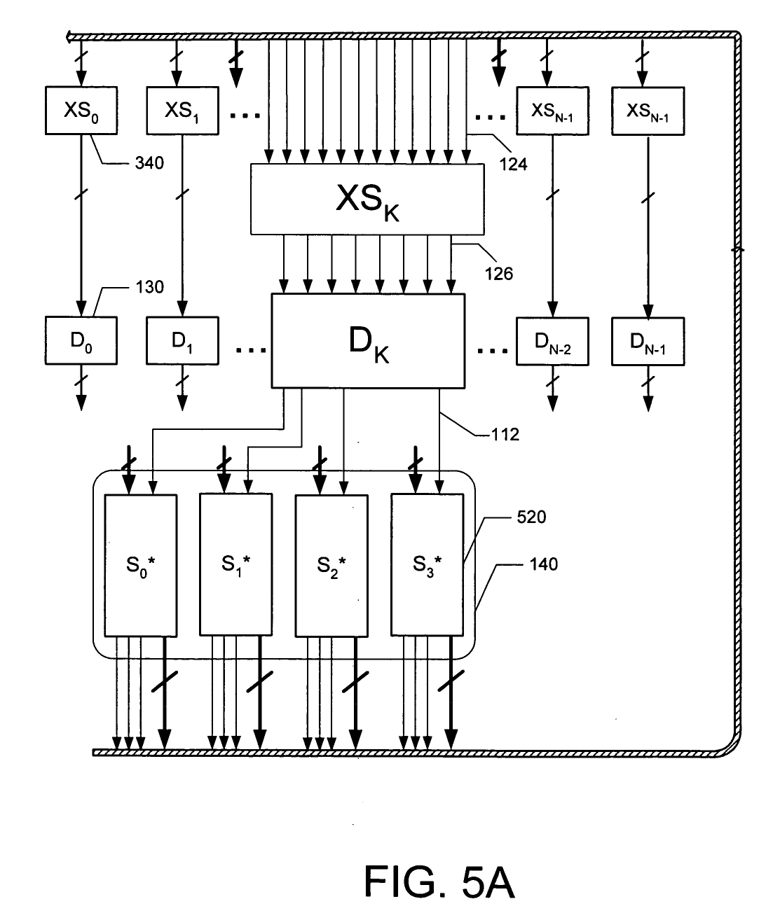

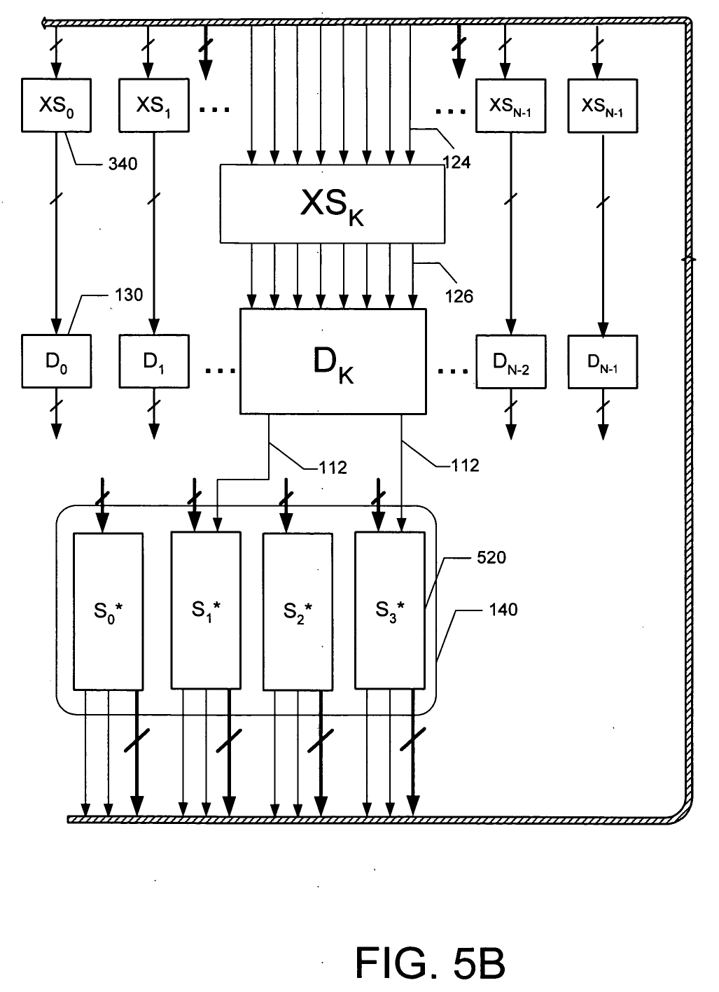

Referring to FIG. 4, a schematic block diagram shows an interconnection from an output row of the network S to an external device 130 via an auxiliary crossbar switch XS 150. The output row of switch S comprises nodes 422 and connections 420, while the auxiliary crossbar switch XS 150 is composed of a plurality of smaller switches XS 150 shown in FIG. 5A. The output connection from switch S to the targeted devices is more complicated than the output connection from switch U to a targeted external device.

FIG. 4 illustrates the basic functions of a crossbar XS switch module. The switch is illustrated as a 6×4 switch with six input lines 124 from the plurality of nodes 422 on the transmission line 420 to the four input buffers B₀, B₁, B₂ and B₃ of the external device D 130. Of the six input lines, no more than four can be hot, for example carrying data, during a sending cycle. Switch XS may be a simple crossbar switch since each request processor assures that no two packets destined for the same bin can arrive at an output row during any cycle. Since each message packet is targeted for a separate bin in the in the external device 130, the switch is set without conflict. Logic elements 414 set the cross-points defining communication paths. Communication between the logic elements can be avoided since each element controls a single column of the crossbar. Delay FIFOs 410 can be used to synchronize the entrance of segments into the switch. Since two clock ticks are consumed for the header bit of a segment to travel from one node to the next and the two extreme nodes are eleven nodes apart, a delay FIFO of 22 ticks is used for the leftmost node. Other FIFO values reflect the distance of the node from the last node on the line having an input line into the switch. In the illustrative example, switches U, S and the auxiliary switches have a fixed size and the locations of the output ports on the level 0 output row are predetermined. The size and location data is for illustrative purposes only and the concepts disclosed for size apply to systems of other sizes.

In the illustrative example of FIG. 4, a single bottom row of nodes feeds a single device D 130. In other examples, a single row can feed multiple devices. In still other examples multiple rows can feed a single device. Accordingly, the system supports devices of varying sizes and types. A more efficient design generally includes more lines from the bottom line of the network to the auxiliary switch than from the auxiliary switch to the external device. The design removes data from the network in a very efficient manner so that message wrap-around is not possible.

Many control algorithms are usable with the illustrative architecture. Algorithms can be implemented in hardware, software, or a combination of hardware and software.

Using Multiple Switches to Lower Pin Count

Referring to FIG. 1A in conjunction with FIG. 3 and FIG. 4, the schematic block diagrams illustrate an MLML network 120 connecting N external devices D 130. The system 100 shown in FIG. 1A has one line from device D into the network and four lines from the network into device D for each external device D. In an embodiment with auxiliary switch AS 140 on the same integrated circuit chip as a multiple-level-minimum-logic (MLML) network, the network chip of the network S 120 has N input lines and 4·N output lines.

FIG. 5A illustrates a configuration in which the network S 140 is composed of four identical networks S₀*, S₁*, S₂* and S₃* 520 distributed over four integrated circuit chips. A single auxiliary switch AS 140 is associated with the four networks 520. FIG. 5A shows a configuration with N external devices Dₙ. Input and output connections to the device D_{K} are illustrated in detail. Device D_{K} has four output lines 112 to enable sending of data to each of the four network chips S₀*, S₁*, S₂* and S₃* 520. The illustrative network chips each have three data lines positioned to send data to the auxiliary crossbar switch XSK associated with device D_{K}. Switch XS_{K} has twelve input lines 124 and eight output lines 126. The number of lines used in the example is for illustration purposes only. The number of lines used in an actual device is arbitrary. Each of the four S* networks illustrated in FIG. 5A has N input ports and 3·N output ports. Therefore, each of the S* networks has slightly fewer ports, 3N as compared to 4N, than the network S 140 described with reference to FIGS. 1 through 4. The S* networks can be N+1 level double down MLML networks. A device D 130 connected to the S* networks has twice as many input ports and four times as many output ports as a device connected to network S. Therefore, the configuration increases input/output (I/O) capacity of the external devices while decreasing the I/O of the network integrated circuit chips.

The device D that schedules the transfer, specifically the receiving device, has access to information concerning availability of device D input buffers. In the embodiment shown in FIG. 5A, the receiving device D also uses information relating to the future status of lines 124 from the S* switches to the crossbar XS switch associated with device D. The request packet contains information relating to the availability of input buffers and status. The sending device returns an answer packet that indicates the S* switches that will be used. The information is maintained by the data receiving device for usage in future request packets that state the availability of lines 124. Accordingly, the requesting device specifies the input buffer to receive the message packet and the sending device specifies the S* device to be employed. Because a device requesting data may give the sending device a choice of available S* switches, the probability of the sending device finding a free output increases.

The design reduces the total number of pins on an integrated circuit chip while increasing both the number of input ports and the number of output ports for an external device. In many technologies, the MLML network technology can be pin-limited in that, for a particular design and a particular integrated circuit chip, the number levels can be doubled due to the ample silicon real estate to do so. However, the number of pins on an integrated circuit chip cannot be doubled in many cases due to packaging considerations. Usage of multiple S* switches enables the total number of devices to increase beyond the number of devices that can be served by a single integrated circuit chip. Since a sizable percentage of the power of an MLML chip is consumed at the output ports, distribution of the network over multiple integrated circuit chips can also reduce per-chip power usage and generated heat, depending on the particular integrated circuit chip design.

In the embodiment and example shown in FIG. 5A, four integrated circuit chips can be replaced by a single chip. However, the illustrative techniques are general and any number of integrated circuit chips can be used in a configuration. The technique can be extended even to the case illustrated in FIG. 5B, in which a device is not able to receive input data into each of the S* switches, but only into a subset of the switches. The technique allows for additional reduction of switch pin counts per external device. In this way, the number of devices can be doubled by doubling the size of the network on the integrated circuit chip without increasing the pin count on the chip.

Multiple schemes can be used for placing functionality on multiple integrated circuit chips. For example, multiple crossbar XS switches can be placed on a single chip, with each XS switch capable of receiving data from each of the S* switches. In another embodiment, a single XS switch can be placed on the same chip as an individual S* chip. FIG. 5A and the associated description teaches how to replace a single S network with a plurality of networks S* to reduce pin count and increase throughput. Techniques to replace network U with a plurality of networks U* are similar although somewhat more simple and can be practiced by those having ordinary skill in the art.

One of ordinary skill in the art will realize that a wide variety of embodiments can be implemented that distribute the functionality herein over various chips in many configurations.

Connecting Multiple Networks to Build Large Systems

The disclosed techniques for using multiple switches to reduce pin count enable construction of extremely large networks using multiple integrated circuit chips in such a way that each message packet passes through only a single chip. The technique reduces power consumption, reduces latency, and simplifies logic.

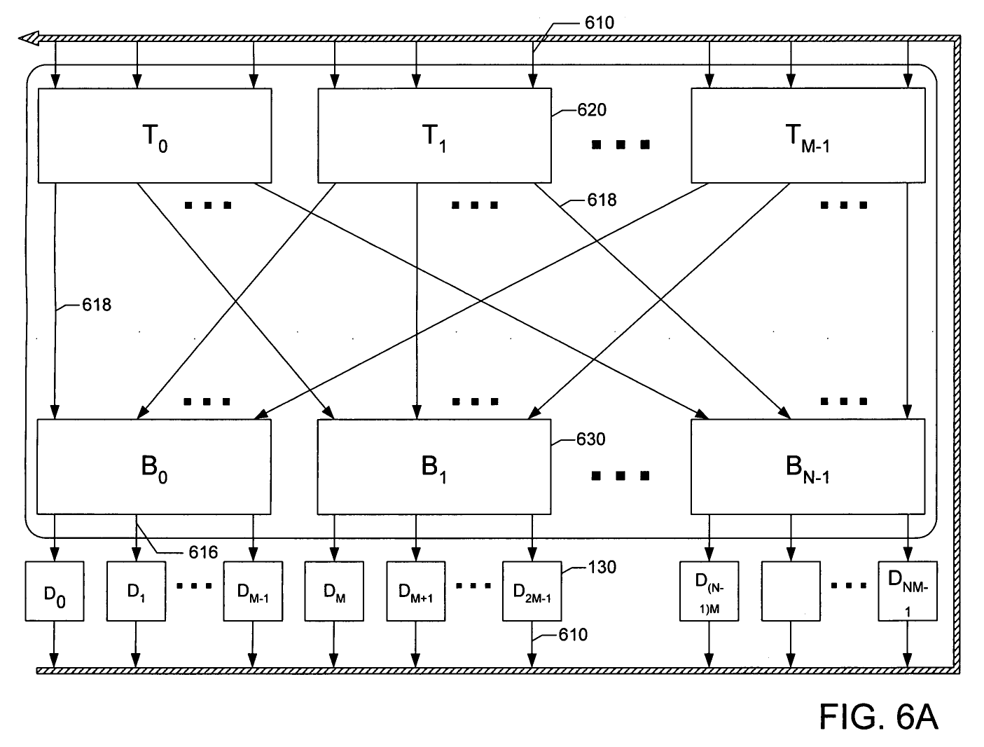

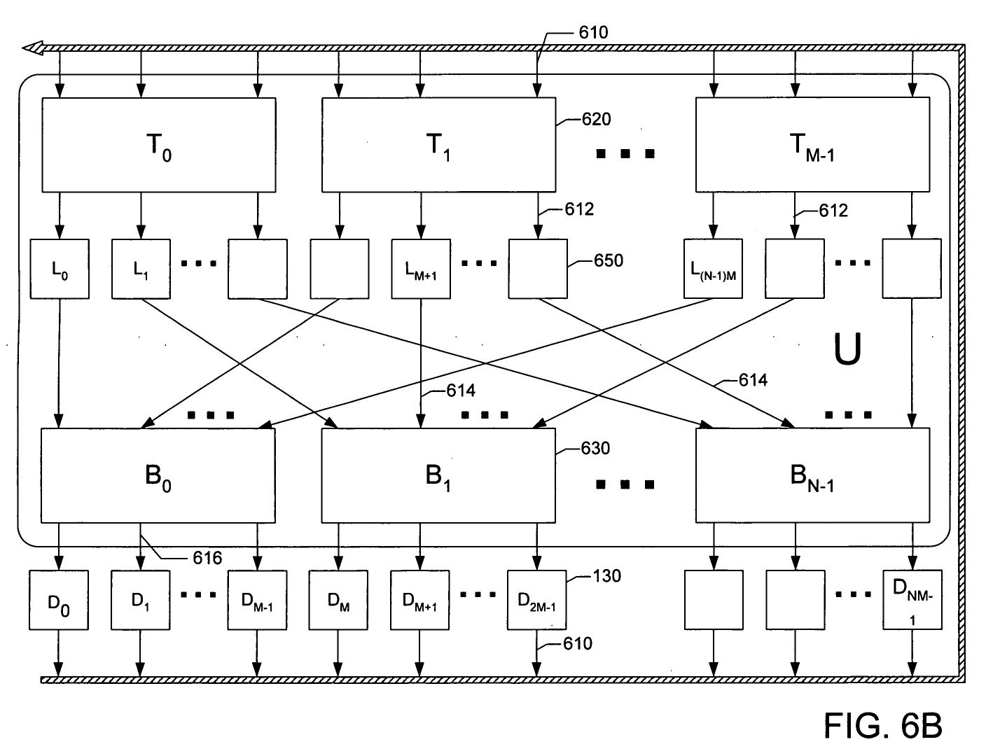

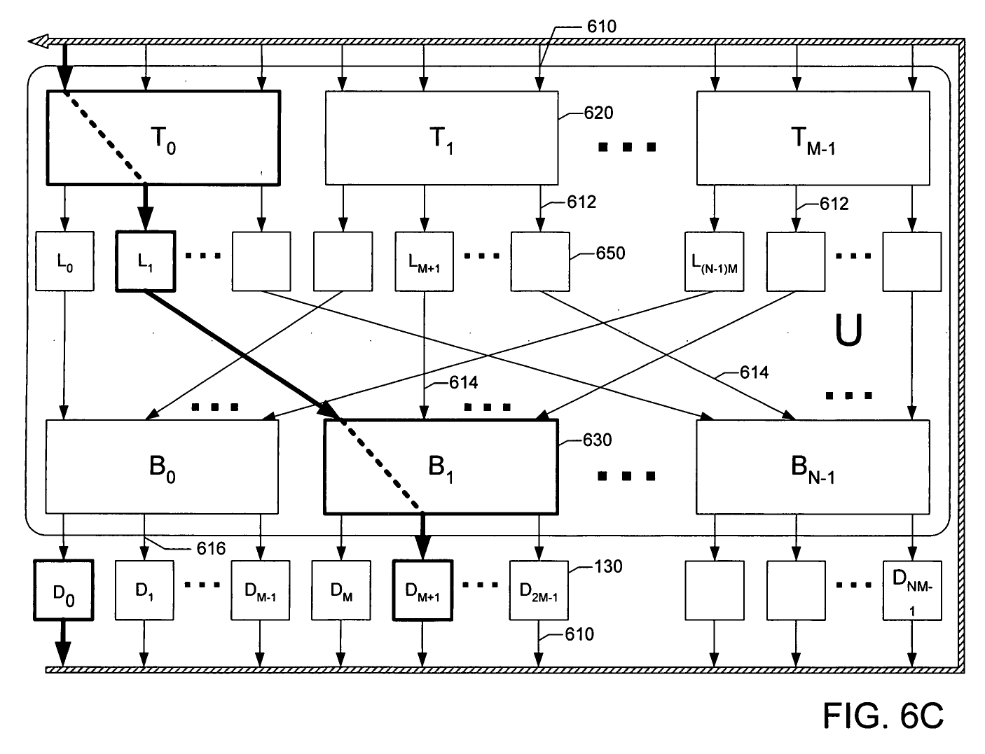

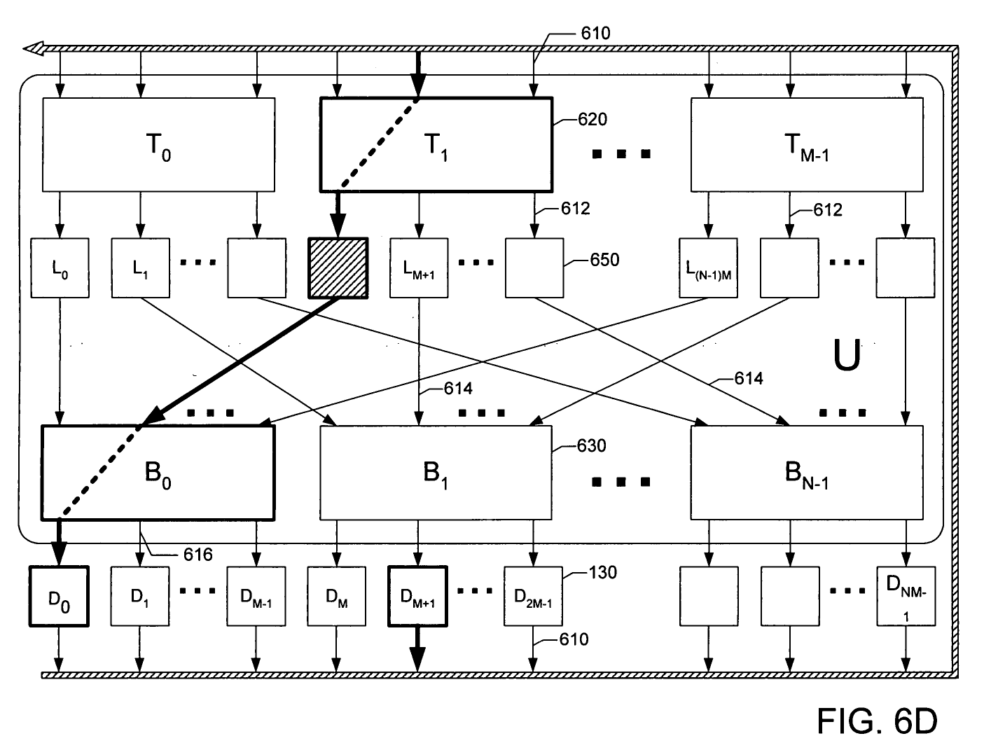

To build networks that support tens or even hundreds of thousands of hosts, other architectures may be used wherein a message passes through more than one integrated circuit chip. The network shown in FIG. 6A exemplifies a type of configuration that can be used as both an uncontrolled and a scheduled network. In the network illustrated in FIG. 6A, messages pass through two switch chips. In case a single integrated circuit chip design enables interconnection of 2^{N} devices, the present design can use 2N such switch chips to interconnect 2^{2N} devices. The configuration is described as a twisted cube architecture and is disclosed in related reference 2. One property of the twisted cube designs illustrated in FIG. 6A through FIG. 6D is that, relative to each bottom switch B_{X}, the device with the smallest subscript is connected by line 610 to switch T₀, the device with the next smallest subscript is connected by line 610 to switch T₁, and so forth, so that the final device with the largest relative subscript is connected by line 610 to switch T_{M-1}. Generally stated, device D_{XM} is connected to receive data from switch B_{X} and to send data to switch T₀. Device D_{XM+1} is connected to receive data from switch B_{X} and to send data to switch T₁. Device D_{XM+2} is connected to receive data from switch B_{X} and to send data to switch T₂, and so forth until finally, device D_{XM+M-1} is connected to receive data from switch B_{X} and to send data to switch T_{M-1}.

The network illustrated in FIG. 6A carries unscheduled messages using switches of the type illustrated in FIG. 2. The control lines are not illustrated in FIG. 6A. Scheduled messages use switches of the type illustrated in FIG. 3.

The network illustrated in FIG. 6B carries unscheduled messages has one purpose of scheduling other messages through the network illustrated in FIG. 6A. The illustrative network shown in FIG. 6B is a twisted cube network of the type illustrated in FIG. 6A, but with the addition the logic elements 650. Networks of the type illustrated in FIG. 6B are used to schedule messages in networks of the type illustrated in FIG. 6A.

In the FIG. 6A design, a message packet P passing from a first external device D_{J} to a second external device D_{K} is sent from D_{J} through a data-carrying line 610 to a first or top MLML switch T_{X} 620. The top switch uses the first N bits of the binary representation of K to send the message packet P out of one N output port sets via a line 618 to a bottom switch B_{Y} 630 that is connected to the target device D_{K}. The top switch does not have auxiliary switches although FIFO shift registers of various lengths can be used, for example in the manner of the FIFOs illustrated in FIG. 4, to cause all data in a cycle to leave the shift registers at the same time and simultaneously enter the bottom switches. In uncontrolled embodiments, the bottom switches are connected to the external devices in the manner described in the description relating to FIG. 2. In controlled embodiments, bottom switches are connected to the external devices in the manner described in the description relating to FIG. 3.

In the following discussion, the scheduled network illustrated in FIG. 6A can be referenced as network or switch S and the unscheduled network illustrated in FIG. 6B can be referenced as network or switch U. Switch U can be used to schedule message packets through switch S. To schedule a message that includes a plurality of packets through network S from a sending device D_{S} to a receiving device D_{R}, a request packet RP can be sent from device D_{R} through network U to device D_{S}. The request packet is used to instigate scheduling of data from device D_{S} to device D_{R} through the network S. When device D_{S} receives the request, device D_{S} processes the request then sends an answer packet AP back to device D_{R}.

The approach complies with the description hereinabove with an exception, in addition to arranging a time interval when device D_{S} is free to send the data and device D_{R} is free to receive the data, the time interval is arranged so that bandwidth from the appropriate top switch connected to device D_{S} to the bottom switch connected to device D_{R} is sufficient. The arrangement is controlled by the logic unit 650 positioned on the appropriate data path. The device D_{R} sends a request packet to device D_{S} identifying the requested data and the times device D_{R} can receive the data. Data receiving times are limited by: 1) future scheduled use of input lines 616 and the associated input port to device D_{R}; and 2) the future scheduled status of the device D_{R} input buffers. The request packet header contains the address of device D_{S} and a flag indicating the packet can pass without examination by logic elements. The payload information states the data size requested and a list of available times for sending to device D_{R}.

The path from device D_{R} to device D_{S} is illustrated in FIG. 6C. While the choice of devices D_{R} and D_{S} are completely arbitrary, in FIG. 6C devices are assigned as R=0 and S=M+1. The packet RP travels through line 610 to a top switch, illustratively switch T₀. In one simple embodiment, multiple lines extend from device D_{R} to the top switch. Packet RP travels through the top switch on the dashed line and exits the top switch on line 612 that connects through a logic unit 650 to the bottom switch connected to device D_{S}. The request packet RP travels through the logic unit, illustratively unit L₁, without examination by the logical unit because the flag is set. Packet RP may be delayed in the logic unit to exit the logic unit at a logic unit sending time. Packet RP proceeds down line 614 to a bottom switch, illustratively switch B₁. The address bits used to route the packet are discarded by the top switch and the bits used to route packet RP through the bottom switch are in the proper position for routing. Packet RP travels through the bottom switch along the dashed line. Packet RP then travels through line 616 to device D_{S}.

The device D_{S} logic determines one or more time intervals for which data can be sent, based on the future scheduled use of the output line. Device D_{S} can function without information relating to the data that is sent. Device D_{S} sends an answer packet AP to device D_{R} indicating the selected times. If no times are available that are consistent with the request packet times, device D_{S} sends a denial message in the answer packet AP.

The request format depends on overall system operation. In one example, the request is for a time reservation of length δ to occur within a time window [T, T+Δ], with Δ≧δ. The request may specify that the data come in only one stream or the request may allow data to come in several streams, with time intervals between the streams. Device D_{S} accepts the request so long as the device has free output port time within the time window [T, T+Δ]. The related reference 8 discloses methods of exchanging scheduling times in request and answer packets. As in the single chip network S, the logic of device D_{S} can enforce quality of service (QoS) in systems utilizing QoS. QoS methods are disclosed in related reference 8. For example, in case multiple lines 610 extend from device D_{S} to the top switch, one or more of the lines can be reserved for high QoS messages. The ability of the system to enforce quality of service even for extremely large systems promotes efficient communication. In the case the answer packet carries a denial, the answer packet AP has a flag indicating that data can pass without examination by a logic unit. In case one or more times are available, the times are indicated in the answer packet AP and a flag is set indicating that the packet is to be examined by a logic unit. In case of denial or an acceptance, device D_{S} sends an answer packet to device D_{R}.

The path of answer packet AP from device D_{S} to device D_{R} is shown in FIG. 6D, where device D_{S} is illustrated as D_{M+1} and device D_{R} is illustrated as D₀). Answer packet AP is sent from device D_{S} to a top switch 620 through line 610 and, based on header information, the top switch, illustrated as T₁, routes the answer packet AP to the bottom switch, illustrated as B₀, that sends data to device D_{R}. Lines from the top switch to the bottom switch pass through a selected logic unit 652 of the logic units 650. The path in switch U from the top switch to the bottom switch comprises: 1) a line 612 connecting the dashed line in the top switch to the shaded logic unit; 2) the logic unit 652; and 3) the line 614 connecting the shaded logic unit to the dashed line in the bottom unit. The path corresponds to a single line 618 in switch S as illustrated in FIG. 6A.

All of the data scheduled to go down the corresponding line in network U is scheduled using an answer packet AP that passes through the logic unit 652. In the example, all data scheduled to use a line 614 from output port 0 of switch T₁ to switch B₀ is scheduled using an answer packet AP that passes through the logic unit 652. The logic unit 652 tracks future availability of all data lines in switch U that pass through the logic unit 652. Accordingly, logic unit 652 can choose a time interval or multiple time intervals from the set of available times specified in the answer packet that requests data to travel from device D_{S} to device D_{R} in switch S.

If the answer packet indicates that no time slot is available, the logic unit allows the answer packet to pass through unaltered. If an answer packet arrives at a logic unit with device D_{S} available times that are not consistent with the logic unit available times, then the logic unit changes the answer packet from an acceptance to a rejection. When a request packet times are consistent with logic unit available times, the logic unit selects and schedules a time for the packet to be sent and alters the answer packet AP to indicate the scheduled time. The logic unit updates a time available table by deleting the scheduled time from the available time list and terminates activities with respect to this scheduling procedure.

The device D_{R} sends the modified answer packet to the device D_{S} indicating acceptance or rejection and, in the case of an acceptance, the time slot that is scheduled. If the device D_{S} sends multiple times but only one time is accepted by the logic unit, the selected time slot cannot be assigned by the device D_{R} until device D_{R} receives an answer packet from the logic unit by way of device D_{S}. If the device D_{S} has multiple output lines 610, the set of times sent by device D_{R} in the answer packet does not restrict the available time list.

If device Dₛ is waiting to receive an altered answer packet from the logic unit 652, device D₅ may hold one or more request packets in memory until the answer packet returns. The answer packet altered by the logic unit has a flag set to the value indicating that the packet can pass without examination by another logic unit. Device D_{R} can respond to a received rejection by resubmitting the request at a later time or, if the desired data is in more than one location, by requesting the data from a second location. The unscheduled network can be over-engineered to run smoothly. The unscheduled network data lines can optionally be designed with a different bandwidth than the scheduled data lines.

If data cannot be scheduled for transmission, the data can be copied to a device connected to a different bottom switch. The devices can access a collection of request and answer packets facilitating network control.

One method of controlling the traffic through switch S is to send request packets through switch U, an effective method for numerous applications including SAN applications. In an example of a parallel computing application, for example including cluster computing, data transferred through network S is scheduled by a compiler that manages computation. Network S can be partitioned simply with all devices connected to a selected subset of bottom switches that perform cluster computation while another set of devices connected to other bottom switches is used for other computation and data moving purposes.

Alternative Multiple Network Scheme

A second example of a large system interconnect scheme arranges devices into a multidimensional array. The two dimensional case will be treated first. The devices are arranged into rows and columns. The number of processors in a row may differ from the number of processors in a column. In the illustrative example presented here, each row and column contains M processors. Nine of the M² devices are illustrated in FIG. 7A. Devices D(0, 0), D(0, 1), . . . , D(0, M−1) are in the first row (at the bottom of FIG. 7A), devices D(1, 0), D(1, 1), . . . , D(1, M−1) are in the second row (in the middle of FIG. 7A), and devices D(M−1, 0), D(M−1, 1), . . . , D(M−1, M−1) are illustrated in the last row (at the top of FIG. 7A). Each device is connected to two unscheduled networks and two scheduled networks. Each of the M unscheduled networks 710 connect M devices in a column. Each of the M scheduled networks 720 also connect M devices in a column. Each row contains M devices connected by an unscheduled network 730 and also by a scheduled network 740. The bidirectional connections 712, 722, 732 and 742 between the devices and the networks include data lines, control lines, switches, and FIFOs. These interconnections are the same as the connections illustrated in FIG. 1A through FIG. 4. Interconnect lines 712 and 732 include lines 112 for carrying data and lines 116 for carrying control signals from devices to unscheduled networks 710 and 730. Lines 712 and 732 also include lines 114 for carrying data and lines 118 for carrying control signals from the unscheduled networks to the devices. Interconnects 722 and 742 carry data between the devices and the scheduled networks. Data travels from the devices to the scheduled networks via lines 122. Data travels from the scheduled networks via lines 124 (and possibly through FIFOs 410) to the auxiliary switch 140 (composed of smaller switches 150) and then from the auxiliary switches to the devices 130 via lines 126. Additionally, for a given device, data can travel directly from one scheduled network to the other scheduled network via line 750 without passing through an external device. In order for the data from different columns on the bottom ring of the sending switch in the scheduled network to arrive at the receiving scheduled network at the proper data insertion time, data may pass through alignment FIFOs similar to the alignment FIFOs 410 illustrated in FIG. 4.

In case each of the 2M networks is on a separate chip, data traveling between nodes in the same row or between nodes in the same column travels through only one network switch. In fact, for such data, the operation of the system is just like the operation of the basic one chip network system. When two devices not on the same row or column communicate, then data travels through two chips. Suppose that a device D(A, B) on row A and column B sends an unscheduled message packet to the device D(X, Y) on row X and column Y and suppose that A≠X and B≠Y. Then D (A, B) sends the message to either D (A, Y) or D(X, B) and asks that device to forward the message to D(X, Y). Consider here the example where D (A, B) sends the message to D(X, B). In effect, the message takes multiple hops from D (A, B) to D(X, Y), but only one of those hops uses a chip to chip move. In the unscheduled network, if the inputs to D(X, B) are overloaded, the message may travel around the network one or more times before the control signal allows the message to exit the first network and enter the device D(X, B). D(X, B) forwards the message to D(X, Y) when the opportunity is available. D(X, Y) is in a position to enforce a quality of service criterion on passing messages. The unscheduled message may be a request to schedule a longer message M including multiple segments. In that case, D (A, B) submits acceptable times to D(X, B). Also, D(X, B) submits to D(X, Y) a set of times that are acceptable to both D (A, B) and D(X, B). D(X, Y) chooses a time interval acceptable to both the sending device and the intermediate device and then returns a timing message T via the intermediate device, which reserves the bandwidth at the arranged time. This timing message T is sent from D(X, B) to D (A, B), after which D (A, B) sends the message M at the acceptable time. The system should be designed so that with a high probability, the acceptance message arrives at D (A, B) prior to the time to send. If not, then D (A, B) arranges another time for sending the message. In case D (A, B) does not receive an acceptance to send a message through D(X, B), and then D (A, B) can attempt to schedule the message by contacting D (A, Y).

In the scheduled network, the message traveling from D(A, B) to D(X,Y) does not actually pass through the intermediate device D(X, B), but in fact travels from the scheduled network connecting the devices on row A to the scheduled network connecting the devices on column Y via interconnect 750. FIG. 7B shows an interconnection between two scheduled networks that does not pass through an intermediate device. Nodes 762 on the bottom ring of a scheduled network are connected using lines 760. In the interconnects described in the incorporated references, including reference 2, a message moves from one node to the next node on the same level in two clock ticks. Therefore, messages leaving the leftmost node 762 exit four ticks before messages leaving two nodes to the right, the next possible time to exit. The FIFOs of various lengths realign the message packets exiting the first network so that messages are time-aligned when entering nodes 766 on the input column of the receiving switch. The data is now in a position to move immediately in the scheduled receiving switch on the same level on lines 782 or progress to a lower level on lines 784 as described in the incorporated references. In addition, the FIFOs align the messages with other messages entering the receiving switch from devices 130 that input data into the switch. In a convenient embodiment, such messages entering from devices enter the receiving switch at nodes that do not receive data directly from another scheduled switch.

The system described in the present section can be combined with the systems described in the section entitled “Using Multiple Switches to Lower Pin Count” so that each of the networks 710, 720, 730 or 740 of FIG. 7A can be instantiated on a plurality of chips. In that case, the messages exiting the nodes on the bottom row of a chip can arrive on different chips holding the second network.

In the example of the present section, the devices 130 are arranged into a two dimensional array. In an example where the devices are arranged into a three dimensional array, each device 130 is connected to six networks, each including a scheduled and unscheduled network for each dimension. Notice that a message traveling from D(A, B, C) to D(X, Y, Z) can take six paths, each including two hops, including the path from D(A, B, C) to D(A, Y, C) to D(A, Y, Z) and finally to D(X, Y, Z). Examples with external devices in an N dimensional array have 2N networks corresponding to each device.

Multiplexing the Scheduled S and Unscheduled U Functions in a Single Network

The network illustrated in FIG. 2 has the property that when a group of messages is inserted into the network at the same column and at the same time, then the first bits of the messages remain column aligned as the messages circulate around the structure. The network can be equipped with FIFO shift registers of the proper length so that the first bit of an incoming message aligns with the first bit of messages already in the system. Accordingly, the network can be used in a mode that supports multiple message lengths. For the case of two packet lengths including long packets of length L and short packets of length S, the FIFO length can be adjusted so that inserted short messages are mutually aligned separate from inserted long messages that are also mutually aligned.

The concept can be extended so that a repetitive process occurs at an insertion column. N long messages are inserted followed by one short message so that scheduled and unscheduled messages use the same structure but are separated and distinguished using time division multiplexing. Long messages, if designated as the scheduled messages, never enter the FIFO structure, a condition that is exploited by implementing a short FIFO. The short FIFO enables request and answer packets to enter but not to circulate back around during periods reserved for long message entry. The FIFO behavior can be attained by circularly shifting the short messages until the data is available to re-enter the portion of the system with logic nodes.

An Embodiment using Additional Networks

FIG. 1A illustrates a system in which each external device D is connected to two networks, a concept that can be extended so that devices are connected to further additional network structures. The technology in the listed references enables and makes practical the extension because the technology, in addition to having high bandwidth and low latency, defines structures that are inexpensive to construct. Some embodiments have two or more unscheduled networks with some unscheduled networks assigned to only handle request and answer packets and some unscheduled networks assigned to handle unscheduled traffic of types other than request and answer packets.

In another embodiment, each device is connected to one or more large systems of the types illustrated in FIG. 6A and FIG. 6B and additionally connected to networks of the type illustrated in FIG. 1A so that devices connected to the same bottom switch can communicate locally through a single hop network and also communicate globally through a multiple hop structure.

An Embodiment using PIM Architecture

The technology in the listed references is highly useful in Program-in-Memory (PIM) architectures using a structure of the type illustrated in FIG. 1A, FIG. 2 or FIG. 3. A PIM architecture device, including the processors, can be built on a single integrated circuit chip. The devices can also be connected to larger networks using the technology described herein. Packets can be scheduled to enter selected pins, optical ports, or ports of another type of a selected device so that data can be targeted for a specific processor on a PIM chip or targeted to a memory area on such a chip. The technique has the potential for greatly expanding computational power.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, components, and dimensions can be varied to achieve the desired structure as well as modifications, which are within the scope of the claims. Variations and modifications of the embodiments disclosed herein may also be made while remaining within the scope of the following claims.

What is claimed is:

1. A method of communicating data formed into multiple-packet messages through a network to an output port comprising:
communicating requests for sending the data to the output port via unscheduled or unmanaged transmission; and
delivering data to the output port in response to the requests via scheduled or managed transmission.

2. The method according to claim 1 further comprising:
communicating the multiple packets of the message in an uninterrupted sequence.

3. The method according to claim 1 further comprising:
communicating the multiple packets of the message in an uninterrupted sequence.

4. A communication apparatus comprising:
a controlled switch capable of communicating scheduled messages and interfacing to a plurality of devices; and
an uncontrolled switch capable of communicating unscheduled messages and interfacing to the plurality of devices, the uncontrolled switch generating signals that schedule the messages in the controlled switch.

5. The apparatus according to claim 4 further comprising:
a device multiply-connected to switches including the controlled switch and the uncontrolled switch.

6. The apparatus according to claim 4 further comprising:
a device comprising a plurality of input/output ports coupled to the controlled switch and the uncontrolled switch, the controlled switch and uncontrolled switch being capable of targeting a message to a specific port of the plurality of ports.

7. The apparatus according to claim 4 further comprising:
a device comprising a plurality of input/output ports coupled to the controlled switch and the uncontrolled switch, the controlled switch and uncontrolled switch being capable of targeting and time multiplexing messages from a plurality of sources to a specific port of the plurality of ports.

8. The apparatus according to claim 4 further comprising:
a device comprising a plurality of input/output ports coupled to the controlled switch and the uncontrolled switch, the controlled switch and uncontrolled switch being capable of communicating messages just-in-time to the specific targeted port.

9. The apparatus according to claim 4 further comprising:
a device coupled to the controlled switch and the uncontrolled switch and having a logic that enforces quality-of-service priority of messages.

10. The apparatus according to claim 4 further comprising:
a plurality of devices coupled to the controlled switch and the uncontrolled switch including:
a requesting device having a plurality of input ports including a selected first input port and a selected second input port;
a first sending device specified by the requesting device and requested to send a plurality of message packets to the first input port when the transfer is possible; and
a second sending device specified by the requesting device and requested to send a plurality of message packets to the second input port when the transfer is possible, the requesting device holding open the first and second input ports until the transfer is complete.

11. The apparatus according to claim 4 further comprising:
a plurality of devices coupled to the controlled switch and the uncontrolled switch including:
a requesting device having a plurality of input ports including a selected input port;
a first sending device specified by the requesting device and requested to send a plurality of message packets to the input port; and
a second sending device specified by the requesting device and requested to send a plurality of message packets to the input port, the requesting device controlling timing of sending of message packets from the first and second sending devices whereby the message packets are interleaved.

12. The apparatus according to claim 4 further comprising:
a plurality of devices coupled to the controlled switch and the uncontrolled switch including:
a requesting device having a plurality of input ports including a selected first input port and a selected second input port;
a first sending device specified by the requesting device and requested to send a plurality of message packets to the first input port;
a second sending device specified by the requesting device and requested to send a plurality of message packets to the second input port; and
a receiving device specified by the requesting device, the requesting device synchronizing transmission of first and second packet streams by the first and second sending devices respectively to the first and second input ports, performing a function, packet by packet, on packets from the first and second packet streams, and transferring a function result stream to the receiving device.

13. The apparatus according to claim 4 further comprising:
a plurality of devices coupled to the controlled switch and the uncontrolled switch including:
a requesting device;
a plurality of processing devices;
a plurality of sending devices specified by the requesting device and requested to send a plurality of message packets to processing devices specified by the requesting device;
a receiving device specified by the requesting device, the requesting device synchronizing transmission of multiple packet streams by the specified sending devices respectively to the specified processing devices for performance of a packet-by-packet function on the multiple packet streams, and transferring a function result stream to the receiving device.

14. The apparatus according to claim 4 further comprising:
a plurality of devices coupled to the controlled switch and the uncontrolled switch including:
a requesting device having a plurality of input ports; and
a plurality of sending devices specified by the requesting device and requested to send multiple message packets to specified ones of the plurality of input ports, the requesting device synchronizing transmission of a plurality of packet streams by the specified sending devices respectively to the specified input ports by sending request packets identifying available times to begin transmission, receiving an acknowledgement from the specified sending devices identifying transmission times acceptable to the sending devices, and sending a confirmation packet identifying a scheduled transmission time.

15. The apparatus according to claim 4 further comprising:
a plurality of devices coupled to the controlled switch and the uncontrolled switch, the plurality of devices including at least one device type in a group consisting of computation devices, data storage devices, combined computation and storage devices, interface devices, routers, bridges, communication gateways, Internet Protocol (IP) portals, local area networks, wide area networks, other networks, and interconnect devices.

16. The apparatus according to claim 4 wherein:
the controlled switch and the uncontrolled switch are capable of operating in combination to simultaneously stream messages into first specified input ports of a first selected device from second specified output ports of a second selected device.

17. The apparatus according to claim 4 wherein:
the controlled switch and the uncontrolled switch are capable of operating in combination to continuously stream multiple message packets into specified input port until an entire communication request is complete.

18. The apparatus according to claim 4 further comprising:
a processing-in-memory module coupled to the controlled switch and the uncontrolled switch that manages data delivery through a plurality of data paths.

19. The apparatus according to claim 4 wherein:
the uncontrolled switch is a flat latency switch and the controlled switch is a stair-step configuration flat latency switch.

20. The apparatus according to claim 4 wherein:
a device coupled to the uncontrolled switch can send a message packet into the uncontrolled switch at any message sending time; and
a device coupled to the controlled switch can insert messages into the controlled switch only at scheduled times.

21. A system comprising:
a plurality of devices;
a controlled switch interfaced to the plurality of devices and capable of communicating scheduled messages to selected ones of the devices; and
an uncontrolled switch interfaced to the plurality of devices and capable of communicating unscheduled messages to selected ones of the devices, the uncontrolled switch generating signals that schedule the messages in the controlled switch.

22. The system according to claim 21 wherein:
the plurality of devices include at least one device type in a group consisting of computation devices, data storage devices, combined computation and storage devices, interface devices, routers, bridges, communication gateways, Internet Protocol (IP) portals, local area networks, wide area networks, other networks, and interconnect devices.

23. The system according to claim 21 further comprising:
an auxiliary switch coupled between the controlled switch and the plurality of devices.

24. The system according to claim 21 further comprising:
at least one control line coupled from a device of the device plurality to the uncontrolled switch, the at least one control line for carrying a signal that can block a message from entering the uncontrolled switch in a message conflict condition.

25. The system according to claim 21 further comprising:
at least one control line coupled from the uncontrolled switch to a device of the device plurality, the at least one control line for carrying a signal that can control information flow to the device.

26. The system according to claim 21 wherein:
a device of the device plurality controls message traffic through the controlled switch by sending request packets through the uncontrolled switch.

27. The system according to claim 21 further comprising:
a compiler coupled to the controlled switch capable of scheduling message traffic through the controlled switch.

28. The system according to claim 21 further comprising:
a device of the device plurality that controls message traffic through a first portion of the controlled switch by sending request packets through the uncontrolled switch; and
a compiler coupled to the controlled switch capable of scheduling message traffic through a second portion of the controlled switch.

29. The system according to claim 21 wherein the auxiliary switch further comprises:
at least one cross-bar switch;
a plurality of logic elements coupled to ones of the at least one cross-bar switch and capable of setting cross points; and
a plurality of delay first-in-first-out (FIFO) buffers coupled between the logic elements and cross-bar switches, the FIFO buffers being capable of synchronizing timing of message segments to the cross-bar switches.

30. The system according to claim 21 wherein:
the auxiliary switch further comprises:
at least one cross-bar switch;
a plurality of output lines from ones of the at least one cross-bar switch to at least one device;
a plurality of logic elements coupled to ones of the at least one cross-bar switch and capable of setting cross points;
a plurality of input lines from the controlled switch to the corresponding plurality of logic elements; and
a plurality of delay first-in-first-out (FIFO) buffers coupled between the logic elements and cross-bar switches, the FIFO buffers being capable of synchronizing timing of message segments to the cross-bar switches; and
the number of input lines is greater than the number of output lines.

31. The system according to claim 21 further comprising:
an auxiliary switch coupled between the controlled switch and the device plurality; and
a plurality of controlled switches interfaced between the device plurality and the auxiliary switch.

32. The system according to claim 21 further comprising:
an auxiliary switch coupled between the controlled switch and the plurality of devices;
a plurality of controlled switches interfaced between the device plurality and the auxiliary switch;
a requesting device of the device plurality having a plurality of input ports; and
a sending device of the device plurality, the requesting device specifying an input port of the input port plurality to receive a message packet and the sending device specifying the controlled switch of the controlled switch plurality for carrying the message packet.

33. The system according to claim 21 further comprising:
a plurality of uncontrolled switches interfaced to the device plurality.

34. The system according to claim 21 wherein the plurality of devices include:
a requesting device having a plurality of input ports; and
at least one sending device specified by the requesting device and requested to send multiple message packets to the requesting device, the requesting device sending a request packet through the uncontrolled switch to the at least one sending device, the request packet initiating scheduling of data transmission from the at least one sending device to the requesting device through the controlled switch.

35. The system according to claim 34 wherein:
the requesting device and the at least one specified sending device arrange a time interval when the at least one sending device can transmit the data and the requesting device can receive the data, the time interval accommodating sufficient bandwidth through the controlled switch to transmit the data.

36. The system according to claim 34 wherein:
the requesting device sends a request packet to the at least one sending device identifying data to be transmitted and time intervals during which the requesting device can receive the data.

37. The system according to claim 21 wherein the uncontrolled switch comprises:
a plurality of input switches coupled to a plurality of input lines from the plurality of devices;
a plurality of output switches coupled to a plurality of output lines to the plurality of devices; and
a plurality of logic units selectively coupled between ones of the plurality of input switches and ones of the plurality of output switches.

38. The system according to claim 37 wherein:
a logic unit of the logic unit plurality tracks future availability of all data lines in the uncontrolled switch that pass through the logic unit, enabling selection among zero or more intervals during which the data lines are available and devices are available for sending and receiving data;
the logic unit optionally modifies timing selection packets according to the selected intervals; and
the logic unit communicates the optionally modified timing selection packets between the devices available for sending and receiving data, or alternatively communicates a rejection packet in a condition that no timing interval is available.

39. The system according to claim 38 wherein:
the logic unit can selectively transmit the data to an alternative device in a condition that no timing interval is available.
